(19) United States
(12) Patent Application Publication
(10) Pub. No.: US 2025/0168724 A1
(43) Pub. Date: May 22, 2025

(54) METHODS AND APPARATUSES FOR A HANDOVER PREPARATION IN A L2 U2N RELAY CASE

(71) Applicant: LENOVO (BEIJING) LIMITED, Beijing (CN)

(72) Inventors: Lianhai Wu, Beijing (CN); Congchi Zhang, Shanghai (CN); Mingzeng Dai, Shanghai (CN); Yibin Zhuo, Shanghai (CN); Min Xu, Beijing (CN)

(21) Appl. No.: 18/841,039

(22) PCT Filed: Apr. 8, 2022
(86) PCT No.: PCT/CN2022/085839

§ 371 Date: Aug. 23, 2024

(51) Int. Cl. H04W 36/00; H04W 88/04

(52) U.S. Cl. CPC H04W 36/0079; H04W 88/04

(57) ABSTRACT

Embodiments of the present application relate to methods and apparatuses for a handover preparation in which a target node is a layer-2 (L2) UE-to-Network (U2N) relay case. According to an embodiment of the present application, a target network node includes a transceiver and a processor coupled to the transceiver; and the processor is configured: to receive a handover request message via the transceiver from a source network node, wherein the handover request message includes: one or more measurement results associated with at least one candidate relay UE, identifier (ID) information of one candidate relay UE, or ID information of two or more candidate relay UEs; and to transmit a response message via the transceiver to the source network node, wherein the response message includes a handover request acknowledge message or a handover preparation failure message.

### TECHNICAL FIELD

Embodiments of the present application generally relate to wireless communication technology, in particular to methods and apparatuses for a handover preparation in which a target node is a layer-2 (L2) UE-to-Network (U2N) relay case.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system. A U2N relay UE is a UE that provides functionality to support connectivity to the network for U2N remote UE(s).

Currently, in a wireless communication system or the like, details regarding a handover preparation in which a target node is a L2 U2N relay case have not been specifically discussed yet.

### SUMMARY

Some embodiments of the present application provide a target network node (e.g., a target base station (BS)). The target network node includes a transceiver and a processor coupled to the transceiver; and the processor is configured: to receive a handover request message via the transceiver from a source network node, wherein the handover request message includes: one or more measurement results associated with at least one candidate relay UE, identifier (ID) information of one candidate relay UE, or ID information of two or more candidate relay UEs; and to transmit a response message via the transceiver to the source network node, wherein the response message includes a handover request acknowledge message or a handover preparation failure message.

In some embodiments, the handover request message includes a preferred RRC state of the target relay UE.

In some embodiments, the handover request message includes ID information of a target cell of the target network node.

In some embodiments, in response to the handover request message including the ID information of the target cell, the one target relay UE and the two or more target relay UEs are served by the target cell.

In some embodiments, in response to the handover request message including the one or more measurement results, the handover request message further includes an indication for indicating the target network node to select a target relay UE.

In some embodiments, the indication is an indication for indicating the target network node to select a target relay UE served by a target cell of the target network node.

In some embodiments, to transmit the response message, the processor of the target network node is configured: in response to the handover request message including the one or more measurement results: to select one target relay UE; or to select two or more target relay UEs; and to transmit the handover request acknowledge message via the transceiver to the source network node, wherein the handover request acknowledge message includes ID information of the one target relay UE or ID information of the two or more target relay UEs.

In some embodiments, to transmit the response message, the processor of the target network node is configured: in response to the handover request message including the ID information of the one candidate relay UE, to determine whether the one candidate relay UE can serve a UE; and in response to determining that the one candidate relay UE can serve the UE, to transmit the handover request acknowledge message including the ID information of the one candidate relay UE via the transceiver to the source network node.

In some embodiments, to transmit the response message, the processor of the target network node is configured: in response to the handover request message including the ID information of the one candidate relay UE, to determine whether the one candidate relay UE can serve a UE; and in response to determining that the one candidate relay UE cannot serve the UE, to transmit the handover preparation failure message to the source network node.

In some embodiments, in response to the handover request message including the ID information of the one candidate relay UE, to transmit the response message, the processor of the target network node is configured: to select a first target relay UE different from the one candidate relay UE, and to transmit the handover request acknowledge message including ID information of the first target relay UE to the source network node.

In some embodiments, to transmit the response message, the processor of the target network node is configured: in response to the handover request message including the ID information of the two or more candidate relay UEs: to select one target relay UE within the two or more candidate relay UEs; or to select two or more target relay UEs within the two or more candidate relay UEs; or to select a second target relay UE different from the two or more candidate relay UEs; and to transmit the handover request acknowledge message via the transceiver to the source network node, wherein the handover request acknowledge message includes: ID information of the one target relay UE, ID information of the two or more target relay UEs, or ID information of the second target relay UE.

In some embodiments, the handover request acknowledge message includes ID information of a target cell of the target network node.

In some embodiments, in response to the handover request acknowledge message including the ID information of the target cell, the first target relay UE and the second target relay UE are served by the target cell.

In some embodiments, the ID information of the target cell includes a cell global ID, and wherein the cell global ID includes at least one of: a public land mobile network (PLMN) ID, or a cell ID of the target cell.

In some embodiments, in response to the handover request message including at least one of the ID information of the one candidate relay UE or the ID information of the two or more candidate relay UE, to transmit the response message, the processor of the target network node is configured to transmit the handover preparation failure message to the source network node.

In some embodiments, the handover preparation failure message includes at least one of: a failure cause; or ID information of a third candidate relay UE, wherein the third candidate relay UE is different from the at least one candidate relay UE, the one candidate relay UE, and the two or more candidate relay UE, and wherein the third candidate relay UE can serve a UE.

In some embodiments, the failure cause includes at least one of: no relay UE being available; no radio resource being available in the at least one candidate relay UE; no radio resource being available in the one candidate relay UE; or no radio resource being available in the two or more candidate relay UE.

In some embodiments, at least one of the ID information of the one candidate relay UE or the ID information of the two or more candidate relay UEs includes at least one of: a source Layer-2 ID; a cell radio network temporary identifier (C-RNTI); or a temporary mobile subscriber identity (TMSI).

Some embodiments of the present application provide a method, which may be performed by a target network node (e.g., a target BS). The method includes: receiving a handover request message from a source network node, wherein the handover request message includes: one or more measurement results associated with at least one candidate relay UE, identifier (ID) information of one candidate relay UE, or ID information of two or more candidate relay UEs; and transmitting a response message to the source network node, wherein the response message includes a handover request acknowledge message or a handover preparation failure message.

Some embodiments of the present application provide a source network node (e.g., a source BS). The source network node includes a transceiver and a processor coupled to the transceiver; and the processor is configured: to decide to switch a UE to a target relay UE, wherein the target relay UE is served by a target network node; to transmit a handover request message via the transceiver to the target network node, wherein the handover request message includes: one or more measurement results associated with at least one candidate relay UE, identifier (ID) information of one candidate relay UE, or ID information of two or more candidate relay UEs; and to receive a response message via the transceiver from the target network node, wherein the response message includes a handover request acknowledge message or a handover preparation failure message.

In some embodiments, the handover request message includes a preferred RRC state of the target relay UE.

In some embodiments, the handover request message includes ID information of a target cell of the target network node.

In some embodiments, in response to the handover request message including the ID information of the target cell, the one target relay UE and the two or more target relay UEs are served by the target cell.

In some embodiments, in response to the handover request message including the one or more measurement results, the handover request message further includes an indication for indicating the target network node to select a target relay UE.

In some embodiments, the indication is an indication for indicating the target network node to select a target relay UE served by a target cell of the target network node.

In some embodiments, in response to the handover request message including the one or more measurement results and in response to receiving the handover request acknowledge message, the handover request acknowledge message includes: ID information of one target relay UE; or ID information of two or more target relay UEs.

In some embodiments, in response to the handover request message including the ID information of the one candidate relay UE and in response to receiving the handover request acknowledge message, the handover request acknowledge message includes: the ID information of the one candidate relay UE in response to determining that the one candidate relay UE can serve the UE; or ID information of a first target relay UE different from the one candidate relay UE.

In some embodiments, in response to the handover request message including the ID information of the two or more candidate relay UEs, and in response to receiving the handover request acknowledge message, the handover request acknowledge message includes: the ID information of one target relay UE selected within the two or more candidate relay UEs; or ID information of two or more target relay UEs selected within the two or more candidate relay UEs; or ID information of a second target relay UE different from the two or more candidate relay UEs.

In some embodiments, the handover request acknowledge message includes ID information of a target cell of the target network node.

In some embodiments, in response to the handover request acknowledge message including the ID information of the target cell, the first target relay UE and the second target relay UE are served by the target cell.

In some embodiments, the ID information of the target cell includes a cell global ID, and the cell global ID includes at least one of: a public land mobile network (PLMN) ID, or a cell ID of the target cell.

In some embodiments, in response to the handover request message including at least one of the ID information of the one candidate relay UE or the ID information of the two or more candidate relay UE, to receive the response message, the processor of the source network node is configured to receive the handover preparation failure message from the target network node.

In some embodiments, the handover preparation failure message includes at least one of: a failure cause; or ID information of a third candidate relay UE, wherein the third candidate relay UE is different from the at least one candidate relay UE, the one candidate relay UE, and the two or more candidate relay UE, and wherein the third candidate relay UE can serve the UE.

In some embodiments, the failure cause includes at least one of: no relay UE being available; or no radio resource being available in the at least one candidate relay UE; no radio resource being available in the one candidate relay UE; or no radio resource being available in the two or more candidate relay UE.

In some embodiments, at least one of the ID information of the one candidate relay UE or the ID information of the two or more candidate relay UEs includes at least one of: a source Layer-2 ID; a cell radio network temporary identifier (C-RNTI); or a temporary mobile subscriber identity (TMSI).

Some embodiments of the present application provide a method, which may be performed by a source network node (e.g., a source BS). The method includes: deciding to switch a UE to a target relay UE, wherein the target relay UE is served by a target network node; transmitting a handover request message to the target network node, wherein the handover request message includes: one or more measurement results associated with at least one candidate relay UE, identifier (ID) information of one candidate relay UE, or ID information of two or more candidate relay UEs; and receiving a response message from the target network node, wherein the response message includes a handover request acknowledge message or a handover preparation failure message.

Some embodiments of the present application provide a user equipment (UE). The UE includes a transceiver and a processor coupled to the transceiver; and the processor is configured: to receive an radio resource control (RRC) reconfiguration message including a path switching indication via the transceiver from a source network node, wherein the path switching indication includes: identifier (ID) information of one candidate relay UE of a target network node, or ID information of two or more candidate relay UEs of the target network node; in response to the path switching indication including the ID information of the one candidate relay UE, to perform a path switching operation to the one candidate relay UE; and in response to the path switching indication including the ID information of the two or more candidate relay UEs, to select one target relay UE within the two or more candidate relay UEs and to perform the path switching operation to the one target relay UE.

In some embodiments, the processor of the UE is configured to perform an RRC re-establishment procedure, in response to ID information of a serving cell which serves the one candidate relay UE or the one target relay UE being different from ID information of a cell included in the RRC reconfiguration message.

In some embodiments, the processor of the UE is configured to start a first timer for the path switching operation to one target relay UE upon receiving the RRC reconfiguration message.

In some embodiments, in response to failing to establish a path between the UE and the one target relay UE, the processor of the UE is configured: to select a second target relay UE within the two or more candidate relay UEs; and to perform a second path switching operation to the second target relay UE.

In some embodiments, the processor of the UE is configured to start a second timer for a consecutive path switching operation upon receiving the RRC reconfiguration message in response to the second timer being configured.

In some embodiments, the processor of the UE is configured: to perform an RRC re-establishment procedure upon an expiry of the second timer; and to stop the second timer in response to the UE transmitting an RRC reconfiguration complete message to the target network node via the second target relay UE.

Some embodiments of the present application provide a method, which may be performed by a UE. The method includes: receiving an radio resource control (RRC) reconfiguration message including a path switching indication from a source network node, wherein the path switching indication includes: identifier (ID) information of one candidate relay UE of a target network node, or ID information of two or more candidate relay UEs of the target network node; in response to the path switching indication including the ID information of the one candidate relay UE, performing a path switching operation to the one candidate relay UE; and in response to the path switching indication including the ID information of the two or more candidate relay UEs, selecting one target relay UE within the two or more candidate relay UEs and performing the path switching operation to the one target relay UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a network node (e.g., a source BS or a target BS) or a UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 1A illustrates an exemplary flow chart for receiving a handover request message in accordance with some embodiments of the present application.

FIG. 1B illustrates an exemplary flow chart for transmitting a handover request message in accordance with some embodiments of the present application.

FIG. 1C illustrates an exemplary flow chart for receiving an RRC reconfiguration message in accordance with some embodiments of the present application.

FIG. 2 illustrates a flow chart of an exemplary procedure of wireless communications in accordance with some embodiments of the present application.

FIG. 3 illustrates a flow chart of an exemplary procedure of wireless communications in accordance with some embodiments of the present disclosure.

FIG. 4 illustrates a flow chart of an exemplary procedure of wireless communications in accordance with some embodiments of the present disclosure.

FIG. 5 illustrates an exemplary block diagram of an apparatus for a L2 U2N relay case in accordance with some embodiments of the present application.

FIG. 6 illustrates a further exemplary block diagram of an apparatus for a L2 U2N relay case in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

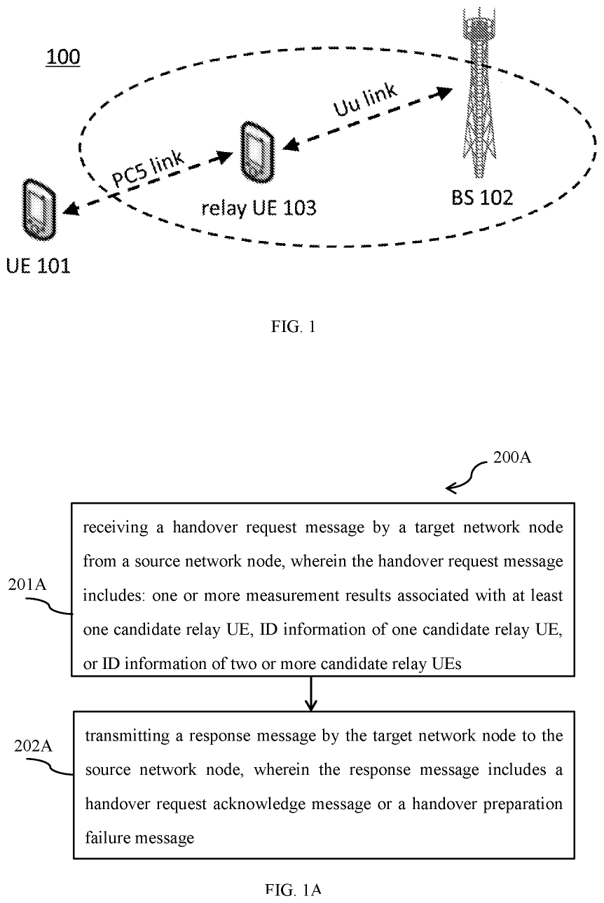

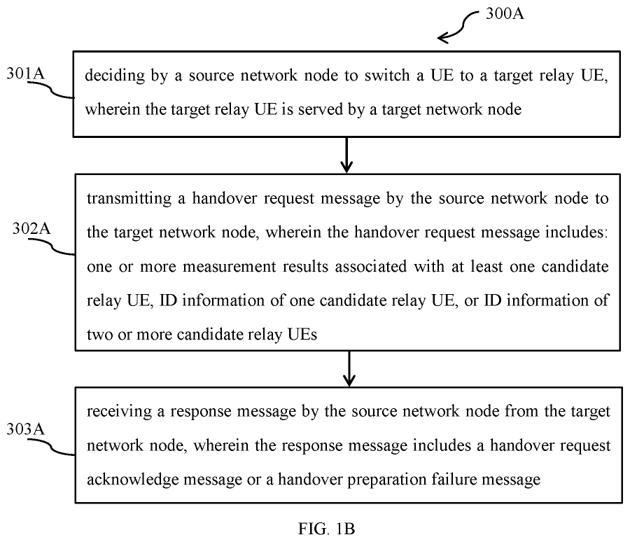

FIG. 1 illustrates a schematic diagram of a wireless communication system 100 in accordance with some embodiments of the present application. As shown in FIG. 1, the wireless communication system 100 includes UE 101, BS 102, and relay UE 103 for illustrative purpose. Although a specific number of UE(s), relay UE(s), and BS(s) are depicted in FIG. 1, it is contemplated that any number of UE(s), relay UE(s), and BS(s) may be included in the wireless communication system 100.

Due to a far distance between UE 101 and BS 102, these they communicate with each other via relay UE 103. UE 101 may be connected to relay UE 103 via a network interface, for example, a PC5 interface as specified in 3GPP standard documents. Relay UE 103 may be connected to BS 102 via a network interface, for example, a Uu interface as specified in 3GPP standard documents. Referring to FIG. 1, UE 101 is connected to relay UE 103 via a PC5 link, and relay UE 103 is connected to BS 102 via a Uu link. UE 101 may be a U2N remote UE. Relay UE 103 may be a U2N relay UE, which is a UE that provides functionality to support connectivity to the network for U2N remote UE(s).

In some embodiments of the present application, UE 101 or relay UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

In some further embodiments of the present application, UE 101 or relay UE 103 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 or relay UE 103 may include wearable devices, such as smart watches, fitness bands, optical head-mounted displays, or the like. Moreover, UE 101 or relay UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL), and UE(s) 101 (e.g., UE 101 or other similar UE) transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 602.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

Some embodiments of the present application refer to switching from direct to indirect path. A gNB (e.g., BS 102 as shown in FIG. 1) can select a U2N Relay UE (e.g., relay UE 103 as shown in FIG. 1) in any RRC state, i.e., RRC_IDLE, RRC_INACTIVE, or RRC_CONNECTED, as a target U2N Relay UE for direct to indirect path switch. For service continuity of L2 U2N Remote UE, the following procedure is used, in case of a L2 U2N Remote UE (e.g., UE 101 as shown in FIG. 1) switching to an indirect path via the U2N Relay UE in RRC_CONNECTED.
(1) Step 1: The U2N Remote UE reports one or multiple candidate U2N Relay UE(s) and Uu measurements, after it measures or discovers the candidate U2N Relay UE(s) (e.g., relay UE 103 as shown in FIG. 1).
   The U2N Remote UE may filter the appropriate U2N Relay UE(s) according to Relay selection criteria before reporting. The U2N Remote UE shall report only the U2N Relay UE candidate(s) that fulfil the higher layer criteria.
   The reporting can include at least an ID of the U2N Relay UE, a serving cell ID of the U2N Relay UE, and sidelink measurement quantity information. The sidelink measurement quantity may be SL-RSRP of the candidate U2N Relay UE, and if SL-RSRP is not available, SD-RSRP is used.
(2) Step 2: The gNB decides to switch the U2N Remote UE to a target U2N Relay UE. Then the gNB sends an RRCReconfiguration message to the target U2N Relay UE, which can include at least Remote UE's local ID and L2 ID, Uu and PC5 Relay RLC channel configuration for relaying, and bearer mapping configuration.
(3) Step 3: The gNB sends the RRCReconfiguration message to the U2N Remote UE. The contents in the RRCReconfiguration message can include at least U2N Relay UE ID, PC5 Relay RLC channel configuration for relay traffic and the associated end-to-end radio bearer(s). The U2N Remote UE stops UP and CP transmission over a Uu interface after reception of RRCReconfiguration message from the gNB.
(4) Step 4: The U2N Remote UE establishes a PC5 connection with target U2N Relay UE.
(5) Step 5: The U2N Remote UE completes the path switch procedure by sending the RRCReconfigurationComplete message to the gNB via the Relay UE.
(6) Step 6: The data path is switched from direct path to indirect path between the U2N Remote UE and the gNB.

Embodiments of the present application aim to solve issues of an inter-gNB path switching in a L2 U2N relay case, e.g., in a use case of switching an inter-gNB direct or indirect path to an indirect path. For example, some embodiments of the present application study a mechanism for a case in which one or more target relay UEs may be included in a handover request acknowledge message. Some embodiments of the present application study a mechanism for a case in which a handover request acknowledge message may include information regarding whether a target BS can select other candidate relay UE, whose ID information is not included in a handover request message, as a target relay. Some embodiments of the present application study a UE's behaviors after receiving a path switching command, e.g., if ID information of two or more candidate relay UEs are included in a path switching command, a UE can select one relay UE for path switching, and optionally, if the UE fails to establish a connection with one candidate relay UE, the UE can attempt to switch to another candidate relay UE. Some embodiments of the present application study a case in which new causes related to a relay UE (e.g., a relay UE is not available, or no radio resource is available in a target relay UE) may be included in a handover preparation failure message. Some embodiments of the present application study a case in which ID information of another relay UE for a suggestion purpose may be included in a handover preparation failure message.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

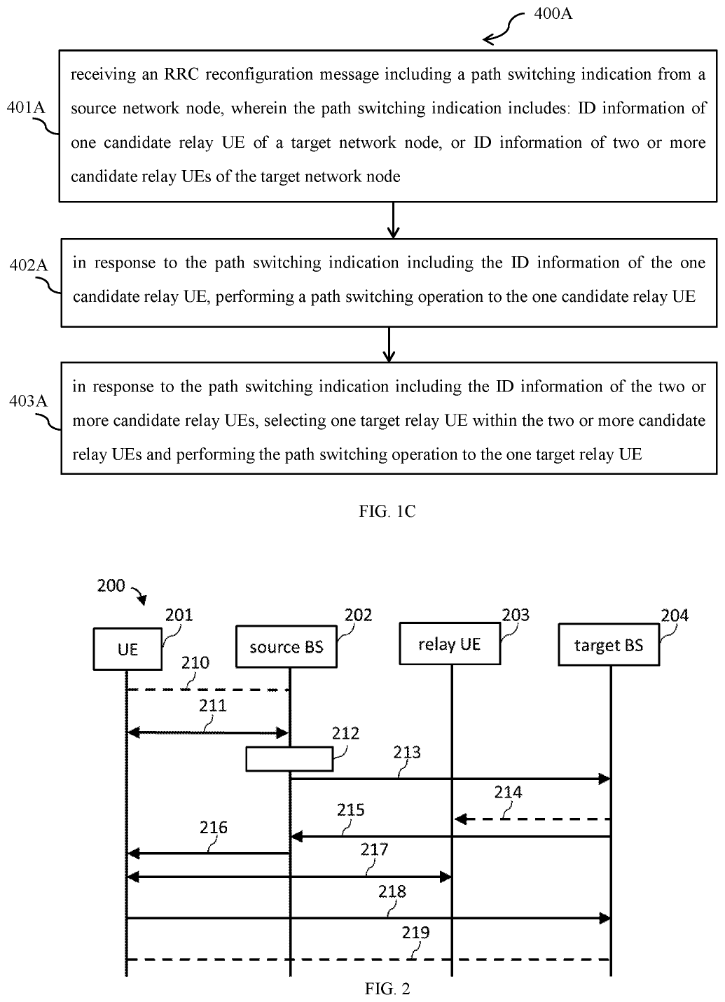

FIG. 1A illustrates an exemplary flow chart for receiving a handover request message in accordance with some embodiments of the present application. The exemplary flow chart 200A may be performed by a target network node (e.g., a target BS). Specific examples of exemplary flow chart 200A are described in embodiments of FIGS. 2-4 as follows. Although described with respect to a target network node, it should be understood that other devices may be configured to perform a method similar to that of FIG. 1A. Details described in all other embodiments of the present application (for example, all details regarding a handover preparation in which a target node is a L2 U2N relay case) are applicable for the exemplary flow chart 200A. Moreover, details described in the exemplary flow chart 200A are applicable for all the embodiments of FIGS. 2-6.

In the exemplary flow chart 200A as shown in FIG. 1A, in operation 201A, a target network node (e.g., target BS 204, target BS 304 or, target BS 403 as shown in any of FIGS. 2-4) receives a handover request message from a source network node (e.g., source BS 202, source BS 302, or source BS 402 as shown in any of FIGS. 2-4). The handover request message includes: one or more measurement results associated with at least one candidate relay UE, ID information of one candidate relay UE, or ID information of two or more candidate relay UEs. In operation 202A, the target network node transmits a response message to the source network node. The response message includes a handover request acknowledge message or a handover preparation failure message.

In some embodiments, the handover request message includes a preferred RRC state of the target relay UE. In some embodiments, the handover request message includes ID information of a target cell of the target network node. In an embodiment, in response to the handover request message including the ID information of the target cell, the one target relay UE and the two or more target relay UEs are served by the target cell. In an embodiment, the ID information of the target cell includes a cell global ID, and the cell global ID includes a public land mobile network (PLMN) ID and/or a cell ID of the target cell.

In some embodiments, in response to the handover request message including the one or more measurement results, the handover request message further includes an indication for indicating the target network node to select a target relay UE. In an embodiment, the indication is an indication for indicating the target network node to select a target relay UE served by a target cell of the target network node.

In some embodiments, in response to the handover request message including the one or more measurement results, the target network node selects one target relay UE or selects two or more target relay UEs, and transmits the handover request acknowledge message to the source network node. The handover request acknowledge message includes ID information of the one target relay UE or ID information of the two or more target relay UEs.

In some embodiments, in response to the handover request message including the ID information of the one candidate relay UE, the target network node determines whether the one candidate relay UE can serve a UE. In response to determining that the one candidate relay UE can serve the UE, the target network node transmits the handover request acknowledge message including the ID information of the one candidate relay UE to the source network node.

In some embodiments, in response to the handover request message including the ID information of the one candidate relay UE, the target network node determines whether the one candidate relay UE can serve a UE. In response to determining that the one candidate relay UE cannot serve the UE, the target network node transmits the handover preparation failure message to the source network node.

In some embodiments, in response to the handover request message including the ID information of the one candidate relay UE, the target network node selects a target relay UE (e.g., relay UE 303A as shown in FIG. 3) different from the one candidate relay UE, and transmits the handover request acknowledge message including ID information of the target relay UE to the source network node.

In some embodiments, in response to the handover request message including the ID information of the two or more candidate relay UEs, the target network node selects one target relay UE within the two or more candidate relay UEs or selects two or more target relay UEs within the two or more candidate relay UEs or selects a further target relay UE (e.g., relay UE 303B as shown in FIG. 3) different from the two or more candidate relay UEs; and the target network node transmits the handover request acknowledge message to the source network node. The handover request acknowledge message includes: ID information of the one target relay UE, ID information of the two or more target relay UEs, or ID information of the further target relay UE.

In some embodiments, the handover request acknowledge message includes ID information of a target cell of the target network node. In an embodiment, in response to the handover request acknowledge message including the ID information of the target cell, the target relay UE (e.g., relay UE 303A as shown in FIG. 3) and the further target relay UE (e.g., relay UE 303B as shown in FIG. 3) are served by the target cell. In an embodiment, the ID information of the target cell includes a cell global ID. The cell global ID includes: a public land mobile network (PLMN) ID, and/or a cell ID of the target cell.

In some embodiments, in response to the handover request message including at least one of the ID information of the one candidate relay UE or the ID information of the two or more candidate relay UE, the target network node transmits the handover preparation failure message to the source network node.

In some embodiments, the handover preparation failure message includes a failure cause and/or ID information of an additional candidate relay UE. The additional candidate relay UE is different from the at least one candidate relay UE, the one candidate relay UE, and the two or more candidate relay UE. The additional candidate relay UE can serve a UE. In an embodiment, the failure cause includes at least one of: no relay UE being available; no radio resource being available in the at least one candidate relay UE; no radio resource being available in the one candidate relay UE; or no radio resource being available in the two or more candidate relay UE.

In some embodiments, the ID information of the one candidate relay UE and/or the ID information of the two or more candidate relay UEs includes: a source Layer-2 ID; a cell radio network temporary identifier (C-RNTI); and/or a temporary mobile subscriber identity (TMSI).

FIG. 1B illustrates an exemplary flow chart for transmitting a handover request message in accordance with some embodiments of the present application. The exemplary flow chart 300A may be performed by a source network node (e.g., a source BS). Specific examples of exemplary flow chart 300A are described in embodiments of FIGS. 2-4 as follows. Although described with respect to a source network node, it should be understood that other devices may be configured to perform a method similar to that of FIG. 1B. Details described in all other embodiments of the present application (for example, all details regarding a handover preparation in which a target node is a L2 U2N relay case) are applicable for the exemplary flow chart 300A. Moreover, details described in the exemplary flow chart 300A are applicable for all the embodiments of FIGS. 2-6.

In the exemplary flow chart 300A as shown in FIG. 1B, in operation 301A, a source network node (e.g., source BS 202, source BS 302, or source BS 402 as shown in any of FIGS. 2-4) decides to switch a UE (e.g., UE 201, UE 301, or UE 401 as shown in any of FIGS. 2-4) to a target relay UE, wherein the target relay UE is served by a target network node (e.g., target BS 204, target BS 304 or, target BS 403 as shown in any of FIGS. 2-4). In operation 302A, the source network node transmits a handover request message to the target network node. The handover request message includes: one or more measurement results associated with at least one candidate relay UE, ID information of one candidate relay UE, or ID information of two or more candidate relay UEs.

In some embodiments, the handover request message includes a preferred RRC state of the target relay UE. In some embodiments, the handover request message includes ID information of a target cell of the target network node. In an embodiment, in response to the handover request message including the ID information of the target cell, the one target relay UE and the two or more target relay UEs are served by the target cell.

In some embodiments, in response to the handover request message including the one or more measurement results, the handover request message further includes an indication for indicating the target network node to select a target relay UE. In an embodiment, the indication is an indication for indicating the target network node to select a target relay UE served by a target cell of the target network node.

In some embodiments, in response to the handover request message including the one or more measurement results and in response to receiving the handover request acknowledge message, the handover request acknowledge message includes: ID information of one target relay UE; or ID information of two or more target relay UEs.

In some embodiments, in response to the handover request message including the ID information of the one candidate relay UE and in response to receiving the handover request acknowledge message, the handover request acknowledge message includes: the ID information of the one candidate relay UE in response to determining that the one candidate relay UE can serve the UE; or ID information of a target relay UE (e.g., relay UE 303A as shown in FIG. 3) different from the one candidate relay UE.

In some embodiments, in response to the handover request message including the ID information of the two or more candidate relay UEs, and in response to receiving the handover request acknowledge message, the handover request acknowledge message includes: the ID information of one target relay UE selected within the two or more candidate relay UEs; or ID information of two or more target relay UEs selected within the two or more candidate relay UEs; or ID information of a further target relay UE (e.g., relay UE 303B as shown in FIG. 3) different from the two or more candidate relay UEs.

In some embodiments, the handover request acknowledge message includes ID information of a target cell of the target network node. In an embodiment, in response to the handover request acknowledge message including the ID information of the target cell, the target relay UE (e.g., relay UE 303A as shown in FIG. 3) and the further target relay UE (e.g., relay UE 303B as shown in FIG. 3) are served by the target cell. For instance, the ID information of the target cell includes a cell global ID, and the cell global ID includes at least one of: a public land mobile network (PLMN) ID, or a cell ID of the target cell.

In some embodiments, in response to the handover request message including at least one of the ID information of the one candidate relay UE or the ID information of the two or more candidate relay UE, the source network node receives the handover preparation failure message from the target network node. In an embodiment, the handover preparation failure message includes a failure cause; and/or ID information of an additional candidate relay UE. The additional candidate relay UE is different from the at least one candidate relay UE, the one candidate relay UE, and the two or more candidate relay UE. The additional candidate relay UE can serve the UE. For instance, the failure cause includes at least one of: no relay UE being available; or no radio resource being available in the at least one candidate relay UE; no radio resource being available in the one candidate relay UE; or no radio resource being available in the two or more candidate relay UE.

In some embodiments, at least one of the ID information of the one candidate relay UE or the ID information of the two or more candidate relay UEs includes: a source Layer-2 ID; a C-RNTI; and/or a TMSI.

FIG. 1C illustrates an exemplary flow chart for receiving an RRC reconfiguration message in accordance with some embodiments of the present application. The exemplary flow chart 400A may be performed by a UE. Specific examples of exemplary flow chart 400A are described in embodiments of FIGS. 2-4 as follows. Although described with respect to a UE, it should be understood that other devices may be configured to perform a method similar to that of FIG. 1C. Details described in all other embodiments of the present application (for example, all details regarding a handover preparation in which a target node is a L2 U2N relay case) are applicable for the exemplary flow chart 400A. Moreover, details described in the exemplary flow chart 400A are applicable for all the embodiments of FIGS. 2-6.

In the exemplary flow chart 400A as shown in FIG. 1C, in operation 401A, a UE (e.g., UE 201, UE 301, or UE 401 as shown in any of FIGS. 2-4) receives an RRC reconfiguration message including a path switching indication from a source network node (e.g., source BS 202, source BS 302, or source BS 402 as shown in any of FIGS. 2-4). The path switching indication includes: ID information of one candidate relay UE of a target network node (e.g., target BS 204, target BS 304 or, target BS 403 as shown in any of FIGS. 2-4), or ID information of two or more candidate relay UEs of the target network node. In operation 402A, in response to the path switching indication including the ID information of the one candidate relay UE, the UE performs a path switching operation to the one candidate relay UE. In operation 403A, in response to the path switching indication including the ID information of the two or more candidate relay UEs, the UE selects one target relay UE within the two or more candidate relay UEs and performs the path switching operation to the one target relay UE.

In some embodiments, the UE performs an RRC re-establishment procedure, in response to ID information of a serving cell which serves the one candidate relay UE or the one target relay UE being different from ID information of a cell included in the RRC reconfiguration message.

In some embodiments, the UE starts a timer for the path switching operation to one target relay UE upon receiving the RRC reconfiguration message.

In some embodiments, in response to failing to establish a path between the UE and the one target relay UE, the UE selects a further target relay UE within the two or more candidate relay UEs and performs a further path switching operation to the further target relay UE.

In some embodiments, the UE starts a further timer for a consecutive path switching operation upon receiving the RRC reconfiguration message in response to the further timer being configured. In some embodiments, the UE performs an RRC re-establishment procedure upon an expiry of the further timer; and stops the further timer in response to the UE transmitting an RRC reconfiguration complete message to the target network node via the further target relay UE.

FIG. 2 illustrates a flow chart of an exemplary procedure 200 of wireless communications in accordance with some embodiments of the present disclosure. The exemplary procedure 200 refers to a procedure for Inter-gNB path switching from a direct or indirect path to an indirect path. In the exemplary procedure 200, a target BS prepares one target relay UE among the candidate relay UE(s) suggested by a source BS. Details described in all other embodiments of the present disclosure are applicable for the embodiments shown in FIG. 2.

Referring to FIG. 2, UE 201, target BS 204, and relay UE 203 may function as UE 101, BS 102, and relay UE 103 as shown in FIG. 1, respectively; and source BS 202 may be one source BS not shown in FIG. 1. In particular, following steps are performed in the exemplary procedure 200.
(1) Step 210: UE 201 accesses the serving BS, e.g., source BS 202, via a direct path or an indirect path between UE 201 and source BS 202. UE 201 stays at an RRC connected state. A UL or DL data transmission can be performed between UE 201 and source BS 202.
(2) Step 211: The measurement configuration and measurement report signalling procedures are performed between UE 201 and source BS 202 to evaluate both relay link measurement and Uu link measurement.
   a) For instance, UE 201 may report measurement result(s) based on configuration(s) received from source BS 202. In a case of the direct path between UE 201 and source BS 202, the measurement result(s) may include measurement result(s) for a cell or a candidate relay UE. In a case of the indirect path between UE 201 and source BS 202 via a relay UE (not shown in FIG. 2, e.g., relay UE#1), the measurement result(s) may include: a cell identifier (ID) of a cell serving this relay UE (e.g., relay UE#1); a source layer-2 ID; and a measurement result of this relay UE (e.g., relay UE#1), e.g., reference signal received power (RSRP).
   b) For instance, UE 201 may report capability information to source BS 202. In some embodiments, the capability information includes at least one of:
      1) whether UE 201 can support path switching to a relay UE with an RRC idle or inactive state;
      2) a maximum number of candidate relay UE(s);
      3) a maximum number of candidate relay UE(s) per one target cell;
      4) a maximum number of candidate relay UE(s) with an RRC idle or inactive state; or
      5) a maximum number of candidate relay UE(s) with an RRC idle or inactive state per one target cell.
(3) Step 212: Source BS 202 decides to switch UE 201. For instance, source BS 202 may decide to switch UE 201 based on the measurement result(s). In one example, source BS 202 decides to switch UE 201 from “the direct path between UE 201 and source BS 202” to “an indirect path including a relay UE”. In a further example, source BS 202 decides to switch UE 301 from “the indirect path between UE 201 and source BS 202 via a relay UE (e.g., relay UE#1)” to “another indirect path including another relay UE”.
(4) Step 213: After the path switching decision in Step 212, source BS 202 transmits a handover request message to target BS 204. There may be following three different options in different embodiments of Step 213, i.e., Options 1-3.
   a) Option 1: In some embodiments, no candidate relay UE is selected by source BS 202, but measurement result(s) associated with candidate relay UE(s) can be included in the handover request message. Target BS 204 can select one target relay UE (e.g., relay UE 203 as shown in FIG. 2) based on the measurement result(s) in the handover request message.
      1) In an embodiment, ID information of a target cell (e.g., cell#1) of target BS 204 (e.g., Target Cell Global ID) is included in the handover request message. Measurement result(s) associated with candidate relay UE(s) belonging to this target cell can be included in the handover request message. For instance, the ID information of the target cell (e.g., cell#1) of target BS 204 may be a Cell Global ID, which includes a PLMN Identity IE and a Cell Identity IE. The leftmost bits of the Cell Identity IE correspond to the ID of target BS 204.
      2) In an embodiment, the handover request message includes an indication to indicate target BS 204 to select one candidate relay UE (e.g., relay UE 203) which is served by the target cell (e.g., cell#1) as a target relay UE for UE 201 for patch switching.
   b) Option 2: In some embodiments, ID information of only one candidate relay UE is allowed to be added in the handover request message. In Option 2, if two candidate relay UEs associated with the same cell are selected by source BS 202, two separate handover request messages are needed to be transmitted from source BS 202 to target BS 204.
   c) Option 3: In some embodiments, ID information of two or more candidate relay UEs is included in the handover request message. Target BS 204 can select one candidate relay UE (e.g., relay UE 203) from these two or more candidate relay UEs, as a target relay UE for UE 201 for path switching. For example, target BS 204 can select a candidate relay UE in an RRC connected state as a target relay UE for UE 201.
   d) In some embodiments, in Option 2 and Option 3, the ID information of a candidate relay UE could be source Layer-2 ID included in a discovery message, C-RNTI, or other kind of UE ID (e.g., TMSI).
   e) In some embodiments of Step 213, the handover request message may include a preferred RRC state of the target relay UE.
   f) In some embodiments of Step 213, a UE indication is included in the handover request message, to indicate that UE 201 is a remote UE.
(5) Step 214 (optional): After target BS 204 receives the handover request message and admits the path switching, target BS 204 may transmit an RRC reconfiguration message to the selected one target relay UE, e.g., relay UE 203.
   a) Step 214 is optional.
      1) If relay UE 203 is in an RRC connected state, target BS 204 will transmit the RRC reconfiguration message to relay UE 203.
      2) If relay UE 203 is in an RRC idle or inactive state, target BS 204 may not send the RRC reconfiguration message to relay UE 203. Or, target BS 204 can transit relay UE 203 to be an RRC connected state and send the RRC reconfiguration message to relay UE 203.
   b) In some embodiments, the RRC reconfiguration message includes at least one of: a local ID and L2 ID of UE 201, Uu and PC5 Relay RLC channel configuration for relaying, and a bearer mapping configuration.
   c) In some embodiments corresponding to Option 1 of Step 213, target BS 204 selects one candidate relay UE (e.g., relay UE 203) as a target relay UE based on the measurement result(s) received in the handover request message. The selected one target relay UE should be served by the target cell (e.g., cell#1) in a case that the ID information of the target cell is indicated in the handover request message.
   d) In some embodiments corresponding to Option 2 of Step 213, if target BS 204 determines that the only one candidate relay UE (e.g., relay UE 203) can serve UE 201, target BS 204 can transmit a handover request acknowledge message including ID information of this only one candidate relay UE. Otherwise, target BS 204 may reject the handover request message via a transmission of a handover preparation failure message.
   e) In some embodiments corresponding to Option 3 of Step 213, if target BS 204 determines that at least one candidate relay UE within the two or more candidate relay UEs can serve UE 201, target BS 204 can select one target relay UE (e.g., relay UE 203) from the two or more candidate relay UEs and transmit a handover request acknowledge message including ID information of this selected one target relay UE.
(6) Step 215: Target BS 204 will transmit a handover request acknowledge message to source BS 202 via Xn interface.
   a) In some embodiments, the handover request acknowledge message includes the ID information of the selected one target relay UE (e.g., relay UE 203).
   b) In some other embodiments, the handover request acknowledge message includes both the ID information of the selected one target relay UE (e.g., relay UE 203) and ID information of the corresponding cell (e.g., cell#1) serving this target relay UE.
(7) Step 216: After source BS 202 receives the handover request acknowledge message, source BS 202 will transmit an RRC reconfiguration message including a path switching indication to UE 201.
(8) Step 217: After receiving the RRC reconfiguration message including the path switching indication, UE 201 executes a path switching procedure, to switch to an indirect path between UE 201 and source BS 202 via relay UE 203. In Step 217, UE 201 establishes a PC5 connection with relay UE 203.
   a) For instance, UE 201 may start a timer (e.g., timer#1) for path switching, upon a reception of the RRC reconfiguration message for path switching.
(9) Step 218: UE 201 transmits an RRC reconfiguration complete message to target BS 204 via relay UE 203.
   a) For instance, UE 201 may stop the timer (e.g., timer#1) for path switching, once UE 201 successfully transmits the RRC reconfiguration complete message (e.g., after receiving radio link control (RLC) feedback) to target BS 204 via relay UE 203.
(10) Step 219: After target BS 204 receives the RRC reconfiguration complete message, target BS 204 transmits a UE context release message to source BS 202. The UL or DL data transmission can be performed in Step 219.

FIG. 3 illustrates a flow chart of an exemplary procedure 300 of wireless communications in accordance with some embodiments of the present disclosure. The exemplary procedure 300 refers to a procedure for Inter-gNB path switching from a direct or indirect path to an indirect path. In the exemplary procedure 300, a target BS prepares one target relay UE or prepares two or more target relay UEs, and the prepared target relay UE(s) may be different from the candidate relay UE(s) suggested by a source BS. Details described in all other embodiments of the present disclosure are applicable for the embodiments shown in FIG. 3.

Referring to FIG. 3, UE 301, target BS 304, and relay UE 303A may function as UE 101, BS 102, and relay UE 103 as shown in FIG. 1, respectively. Source BS 302 may be one source BS not shown in FIG. 1. Relay UE 303B may be one relay UE not shown in FIG. 1. In particular, following steps are performed in the exemplary procedure 300.
(1) Step 310: UE 301 accesses the serving BS, e.g., source BS 302, via a direct path or an indirect path. UE 301 stays at an RRC connected state. A UL or DL data transmission can be performed between UE 301 and source BS 302.
(2) Step 311: The measurement configuration and measurement report signalling procedures are performed between UE 301 and source BS 302 to evaluate both relay link measurement and Uu link measurement.
   a) For instance, UE 301 may report measurement result(s) based on configuration(s) received from source BS 302. In a case of the direct path between UE 301 and source BS 302, the measurement result(s) may include measurement result(s) for a cell or a candidate relay UE. In a case of the indirect path between UE 301 and source BS 302 via a relay UE (not shown in FIG. 3, e.g., relay UE#1), the measurement result(s) may include: a cell ID of a cell serving this relay UE (e.g., relay UE#1); a source layer-2 ID; and a measurement result of this relay UE (e.g., relay UE#1), e.g., RSRP.
   b) For instance, UE 301 may report capability information to source BS 302. In some embodiments, the capability information includes at least one of:
      1) whether UE 301 can support path switching to a relay UE with an RRC idle or inactive state;
      2) a maximum number of candidate relay UE(s);
      3) a maximum number of candidate relay UE(s) per one target cell;
      4) a maximum number of candidate relay UE(s) with an RRC idle or inactive state; or
      5) a maximum number of candidate relay UE(s) with an RRC idle or inactive state per one target cell.
(3) Step 312: Source BS 302 decides to switch UE 301. For instance, source BS 302 may decide to switch UE 301 based on the measurement result(s). In one example, source BS 302 decides to switch UE 301 from “the direct path between UE 301 and source BS 302” to “an indirect path including a relay UE”. In a further example, source BS 302 decides to switch UE 301 from “the indirect path between UE 301 and source BS 302 via a relay UE (e.g., relay UE#1)” to “another indirect path including another relay UE”.
(4) Step 313: After the path switching decision in Step 312, source BS 302 transmits a handover request message to target BS 304. There may be following three different options in different embodiments of Step 313, i.e., Options 1-3.
   a) Option 1: In some embodiments, no candidate relay UE is selected by source BS 302, but measurement result(s) associated with candidate relay UE(s) can be included in the handover request message. Target BS 304 can select a target relay UE (e.g., relay UE 303A and/or relay UE 303B as shown in FIG.
      3) based on the measurement result(s) in the handover request message.
      1) In an embodiment, ID information of a target cell (e.g., cell#1) of target BS 304 (e.g., Target Cell Global ID) is included in the handover request message. Measurement result(s) associated with candidate relay UE(s) belonging to this target cell can be included in the handover request message. For instance, the ID information of the target cell (e.g., cell#1) of target BS 304 may be a Cell Global ID, which includes a PLMN Identity IE and a Cell Identity IE. The leftmost bits of the Cell Identity IE correspond to the ID of target BS 304.
      2) In an embodiment, the handover request message includes an indication to indicate target BS 304 to select a candidate relay UE which is served by the target cell (e.g., cell#1) as a target relay UE (e.g., relay UE 303A and/or relay UE 303B) for UE 301 for patch switching.
   b) Option 2: In some embodiments, ID information of only one candidate relay UE is allowed to be added in the handover request message. In Option 2, if two candidate relay UEs (e.g., relay UE 303A and relay UE 303B) associated with the same cell are selected by source BS 302, two separate handover request messages are needed to be transmitted from source BS 302 to target BS 304.
   c) Option 3: In some embodiments, ID information of two or more candidate relay UEs is included in the handover request message. Target BS 304 can select a candidate relay UE from these two or more candidate relay UEs, as a target relay UE (e.g., relay UE 303A and/or relay UE 303B) for UE 301 for patch switching. For example, target BS 304 can select a candidate relay UE in an RRC connected state as a target relay UE for UE 301.
   d) In some embodiments, in Option 2 and Option 3, the ID information of a candidate relay UE could be source Layer-2 ID included in a discovery message, C-RNTI, or other kind of UE ID (e.g., TMSI).
   e) In some embodiments of Step 313, the handover request message may include a preferred RRC state of the target relay UE.
   f) In some embodiments of Step 313, an UE indication is added in the handover request message, to indicate that UE 301 is a remote UE.
(5) Step 314 (optional): After target BS 304 receives the handover request message and admits the path switching, target BS 304 may transmit an RRC reconfiguration message to the selected one target relay UE (e.g., relay UE 303A) or to the selected two or more target relay UEs (e.g., relay UE 303A and relay UE 303B and/or a target relay UE not shown in FIG. 3).
   a) Step 314 is optional.
      1) If relay UE 303A and/or relay UE 303B are in an RRC connected state, target BS 304 will transmit the RRC reconfiguration message to relay UE 303A and/or relay UE 303B.
      2) If relay UE 303A and/or relay UE 303B are in an RRC idle or inactive state, target BS 304 may not send the RRC reconfiguration message to relay UE 303A and/or relay UE 303B. Or, target BS 304 can transit relay UE 303A and/or relay UE 303B to be an RRC connected state and send the RRC reconfiguration message to relay UE 303A and/or relay UE 303B.
   b) In some embodiments, the RRC reconfiguration message includes at least one of: a local ID and L2 ID of UE 301, Uu and PC5 Relay RLC channel configuration for relaying, and a bearer mapping configuration.
   c) In some embodiments corresponding to Option 1 in Step 313, target BS 304 selects one target relay UE (e.g., relay UE 303A) or selects two or more target relay UEs (e.g., relay UE 303A and relay UE 303B) based on the measurement result(s) received in the handover request message. The selected target relay UE(s) should be served by the target cell (e.g., cell#1) in a case that the ID information of the target cell is indicated in the handover request message.
   d) Some embodiments corresponding to Option 2 in Step 313:
      1) In some embodiments, if target BS 304 determines that the only one candidate relay UE (e.g., relay UE 303A) can serve UE 301, target BS 304 can transmit a handover request acknowledge message including ID information of this only one candidate relay UE.
      2) In some further embodiments, target BS 304 may select another candidate relay UE (e.g., relay UE 303B) as a target relay UE and transmit its ID information in the handover request acknowledge message, if the only one candidate relay UE (e.g., relay UE 303A) is not suitable as the target relay UE in a case that the ID information of the only one candidate relay UE is included in the handover request message.
      3) In some other embodiments, target BS 304 may select another candidate relay UE (e.g., relay UE 303B) as a target relay UE and transmit its ID information in the handover request acknowledge message, regardless of whether the only one candidate relay UE (e.g., relay UE 303A) is suitable as the target relay UE or not.
   e) In some embodiments corresponding to Option 3 in Step 313, if target BS 304 determines that at least one candidate relay UE within the two or more candidate relay UEs can serve UE 301, target BS 304 can select one target relay UE (e.g., relay UE 303A) or select two or more target relay UEs (e.g., relay UE 303A and relay UE 303B) from the at least one candidate relay UE and transmit a handover request acknowledge message including ID information of the selected target relay UE(s) (i.e., relay UE 303A and/or relay UE 303B).
(6) Step 315: Target BS 304 will transmit a handover request acknowledge message including ID information of the selected target relay UE(s) (i.e., relay UE 303A and/or relay UE 303B and/or a target relay UE not shown in FIG. 3) to source BS 302 via Xn interface.
   a) In some embodiments, the handover request acknowledge message includes ID information of the selected one target relay UE (e.g., relay UE 303A) or ID information of the selected two or more target relay UEs (e.g., relay UE 303A and relay UE 303B).
   b) In some embodiments, the handover request acknowledge message includes: (1) ID information of the selected one target relay UE (e.g., relay UE 303A) or ID information of the selected two or more target relay UEs (e.g., relay UE 303A and relay UE 303B); and (2) ID information of the corresponding cell serving the selected target relay UE(s).
      1) In an embodiment, the selected one target relay UE (e.g., relay UE 303A) or the selected two or more target relay UEs (e.g., relay UE 303A and relay UE 303B) may be served by one target cell (e.g., cell#1), and ID information of the one target cell is included in the handover request message received from source BS 302.
(7) Step 316: After source BS 302 receives the handover request acknowledge message, source BS 302 will transmit an RRC reconfiguration message including a path switching indication to UE 301.
(8) Step 317: After receiving the RRC reconfiguration message including the path switching indication, UE 301 executes a path switching procedure, to switch to an indirect path between UE 301 and source BS 302 via relay UE 303A and/or relay UE 303B. In Step 317, UE 301 establishes a PC5 connection with relay UE 303A and/or relay UE 303B.
   a) For instance, UE 301 may start a timer (e.g., timer#1) for path switching to a certain relay UE upon a reception of the RRC reconfiguration message for path switching. In addition, UE 301 may start a further timer (e.g., timer#2) for a consecutive path switching operation.
   b) In some embodiments, if ID information of only one candidate relay UE (e.g., relay UE 303A) is included in the reconfiguration with sync IE (e.g., a path switching command) within the RRC reconfiguration message, UE 301 can attempt to establish a connection with the only one candidate relay UE before an expiry of the timer (e.g., timer#1).
   c) In some embodiments, if ID information of two or more candidate relay UEs (e.g., relay UE 303A and/or relay UE 303B) is included in the reconfiguration with sync IE (e.g., a path switching command) within the RRC reconfiguration message, UE 301 can select one relay UE (e.g., relay UE 303A) for path switching. In an embodiment, UE 301 can select one relay UE in an RRC connected state within these two or more candidate relay UEs in priority.
      1) In an embodiment, if UE 301 fails to establish a connection with the firstly selected relay UE (e.g., relay UE 303A), for instance, when the timer for path switching (e.g., timer#1) expires, UE 301 can attempt to establish a connection with a further candidate relay UE (e.g., relay UE 303B) before the expiry of the further timer (e.g., timer#2). For example, UE 301 may select the further candidate relay UE within the two or more candidate relay UEs and perform a path switching operation to the further candidate relay UE. If UE 301 also fails to establish the connection with the further candidate relay UE, UE 301 can attempt to establish a connection with another candidate relay UE before the expiry of the further timer (e.g., timer#2). When the further timer expires (e.g., timer#2 expires), UE 301 may perform an RRC re-establishment procedure.
(9) Step 318: After successfully establishing a PC5 connection with relay UE 303A and/or relay UE 303B, UE 301 transmits an RRC reconfiguration complete message to target BS 304 via relay UE 303A and/or relay UE 303B.
   a) In some embodiments, UE 301 may stop the timer for path switching (e.g., timer#1), once UE 301 successfully transmits the RRC reconfiguration complete message (e.g., after receiving radio link control (RLC) feedback) to target BS 304 via relay UE 303A and/or relay UE 303B.
   b) In some embodiments, UE 301 may stop the further timer (e.g., timer#2), once UE 301 transmits the RRC reconfiguration complete message to target BS 304 via relay UE 303A and/or relay UE 303B.
(10) Step 319: After target BS 304 receives the RRC reconfiguration complete message, target BS 304 transmits a UE context release message to source BS 302. The UL or DL data transmission can be performed in Step 319.

It should be appreciated by persons skilled in the art that the sequence of the operations in exemplary procedure 300 in FIG. 3 may be changed and some of the operations in exemplary procedure 300 in FIG. 3 may be eliminated or modified, without departing from the spirit and scope of the disclosure.

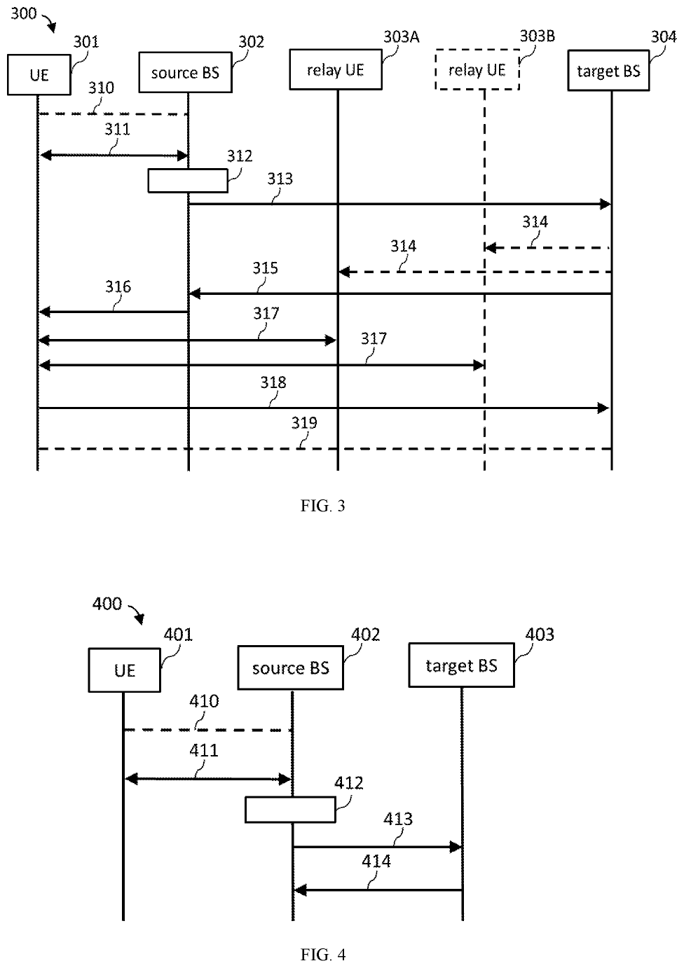

FIG. 4 illustrates a flow chart of an exemplary procedure 400 of wireless communications in accordance with some embodiments of the present disclosure. Exemplary procedure 400 refers to a scenario in which a target BS fails to prepare one or more target relay UEs. Details described in all other embodiments of the present disclosure are applicable for the embodiments shown in FIG. 4.

Referring to FIG. 4, UE 401 and target BS 403 may function as UE 101 and BS 102 as shown in FIG. 1, respectively; and source BS 402 may be one source BS not shown in FIG. 1. In particular, following steps are performed in the exemplary procedure 400.
(1) Step 410: UE 401 accesses the serving BS, e.g., source BS 402, via a direct path or an indirect path. UE 401 stays at an RRC connected state. A UL or DL data transmission can be performed between UE 401 and source BS 402.
(2) Step 411: The measurement configuration and measurement report signalling procedures are performed between UE 401 and source BS 402 to evaluate both relay link measurement and Uu link measurement.
   a) For instance, UE 401 may report measurement result(s) based on configuration(s) received from source BS 402. In a case of the direct path between UE 401 and source BS 402, the measurement result(s) may include measurement result(s) for a cell or a candidate relay UE. In a case of the indirect path between UE 401 and source BS 402 via a relay UE (not shown in FIG. 4, e.g., relay UE#1), the reported measurement result(s) may include: a cell identifier (ID) of a cell serving this relay UE (e.g., relay UE#1); a source layer-2 ID; and a measurement result of this relay UE (e.g., relay UE#1), e.g., RSRP.
   b) For instance, UE 401 may report capability information to source BS 402. In some embodiments, the capability information includes at least one of:
      1) whether UE 401 can support path switching to a relay UE with an RRC idle or inactive state;
      2) a maximum number of candidate relay UE(s);
      3) a maximum number of candidate relay UE(s) per one target cell;
      4) a maximum number of candidate relay UE(s) with an RRC idle or inactive state; or
      5) a maximum number of candidate relay UE(s) with an RRC idle or inactive state per one target cell.
(3) Step 412: Source BS 402 decides to switch UE 401. For instance, source BS 402 may decide to switch UE 401 based on the measurement result(s). In one example, source BS 402 decides to switch UE 401 from the direct path between UE 401 and source BS 402 to an indirect path including a relay UE. In a further example, source BS 402 decides to switch UE 401 from the indirect path between UE 401 and source BS 402 via a relay UE (e.g., relay UE#1) to another indirect path including another relay UE.
(4) Step 413: After the path switching decision in Step 412, source BS 402 transmits a handover request message to target BS 403. There may be following three different options in different embodiments of Step 413, i.e., Options 1-3.
   a) Option 1: In some embodiments, no candidate relay UE is selected by source BS 402. But, measurement result(s) associated with candidate relay UE(s) can be included in the handover request message. Target BS 403 can select a target relay UE based on the measurement result(s) in the handover request message.
      1) In an embodiment, ID information of a target cell (e.g., cell#1) of target BS 403 (e.g., Target Cell Global ID) is included in the handover request message. Measurement result(s) associated with candidate relay UE(s) belonging to this target cell can be included in the handover request message. For instance, the ID information of the target cell (e.g., cell#1) of target BS 403 may be a Cell Global ID, which includes a PLMN Identity IE and a Cell Identity IE. The leftmost bits of the Cell Identity IE correspond to the ID of target BS 403.
      2) In an embodiment, the handover request message includes an indication to indicate target BS 403 to select a candidate relay UE which is served by the target cell (e.g., cell#1) as a target relay UE for UE 401 for patch switching.
   b) Option 2: In some embodiments, ID information of only one candidate relay UE is allowed to be added in the handover request message. In Option 2, if two candidate relay UEs associated with the same cell are selected by source BS 402, two separate handover request messages are needed to be transmitted from source BS 402 to target BS 403.
   c) Option 3: In some embodiments, ID information of two or more candidate relay UEs is included in the handover request message. Target BS 403 can select a candidate relay UE from these two or more candidate relay UEs as a target relay UE for UE 401 for patch switching. For example, target BS 403 can select a candidate relay UE in an RRC connected state as a target relay UE for UE 401.
   d) In some embodiments, in Option 2 and Option 3, the ID information of a candidate relay UE could be source Layer-2 ID included in a discovery message, C-RNTI, or other kind of UE ID (e.g., TMSI).
   e) In some embodiments of Step 413, the handover request message may include a preferred RRC state of the target relay UE.
   f) In some embodiments of Step 413, a UE indication is included in the handover request message, to indicate that UE 401 is a remote UE.
(5) Step 414: Target BS 403 transmits a handover preparation failure message to source BS 402 via Xn interface.
   a) In some embodiment, if the candidate relay UE is not reached or found by target BS 403, target BS 403 transmits the handover preparation failure message.
   b) In some embodiment, the handover preparation failure message includes a failure cause (e.g., “no relay UE being available” or “no radio resource being available in a target relay UE”).
   c) In some embodiments, ID information of another relay UE can be included in the handover preparation failure message for a suggestion purpose. Source BS 402 can trigger a further handover request procedure based on the suggested relay UE.

It should be appreciated by persons skilled in the art that the sequence of the operations in exemplary procedure 400 in FIG. 4 may be changed and some of the operations in exemplary procedure 400 in FIG. 4 may be eliminated or modified, without departing from the spirit and scope of the disclosure.

Some embodiments of the present application also provide a wireless communication apparatus for a L2 U2N relay case. For example, FIG. 5 illustrates an exemplary block diagram of an apparatus 500 for a L2 U2N relay case in accordance with some embodiments of the present application.

As shown in FIG. 5, the apparatus 500 may include at least one non-transitory computer-readable medium 502, at least one receiving circuitry 504, at least one transmitting circuitry 506, and at least one processor 508 coupled to the non-transitory computer-readable medium 502, the receiving circuitry 504 and the transmitting circuitry 506. The at least one processor 508 may be a CPU, a DSP, a microprocessor etc. The apparatus 500 may be a network apparatus (e.g., a source BS or a target BS) or a UE (e.g., a remote UE) configured to perform a method illustrated in the above or the like.

Although in this figure, elements such as the at least one processor 508, receiving circuitry 504, and transmitting circuitry 506 are described in the singular, the plural is contemplated unless a limitation to the singular is explicitly stated. In some embodiments of the present application, the receiving circuitry 504 and the transmitting circuitry 506 can be combined into a single device, such as a transceiver. In certain embodiments of the present application, the apparatus 500 may further include an input device, a memory, and/or other components.

In some embodiments of the present application, the non-transitory computer-readable medium 502 may have stored thereon computer-executable instructions to cause a processor to implement the method with respect to a remote UE or a network apparatus (e.g., a source BS or a target BS) as described above. For example, the computer-executable instructions, when executed, cause the processor 508 interacting with receiving circuitry 504 and transmitting circuitry 506, so as to perform the steps with respect to a remote UE or a network apparatus (e.g., a source BS or a target BS) as illustrated above.

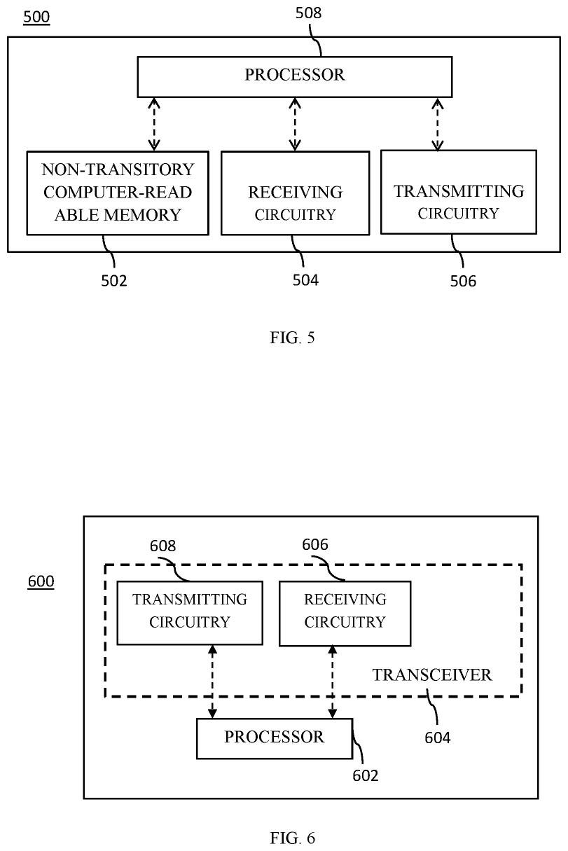

FIG. 6 illustrates a further exemplary block diagram of an apparatus 600 for a L2 U2N relay case in accordance with some embodiments of the present application.

Referring to FIG. 6, the apparatus 600, for example a BS or a UE, may include at least one processor 602 and at least one transceiver 604 coupled to the at least one processor 602. The transceiver 604 may include at least one separate receiving circuitry 606 and transmitting circuitry 608, or at least one integrated receiving circuitry 606 and transmitting circuitry 608. The at least one processor 602 may be a CPU, a DSP, a microprocessor etc.

According to some embodiments of the present application, when the apparatus 600 is a target BS, the processor 602 is configured: to receive a handover request message via the transceiver 604 from a source network node, wherein the handover request message includes: one or more measurement results associated with at least one candidate relay UE, identifier (ID) information of one candidate relay UE, or ID information of two or more candidate relay UEs; and to transmit a response message via the transceiver 604 to the source network node, wherein the response message includes a handover request acknowledge message or a handover preparation failure message.

According to some embodiments of the present application, when the apparatus 600 is a source BS, the processor 602 is configured: to decide to switch a UE to a target relay UE, wherein the target relay UE is served by a target network node; to transmit a handover request message via the transceiver 604 to the target network node, wherein the handover request message includes: one or more measurement results associated with at least one candidate relay UE, identifier (ID) information of one candidate relay UE, or ID information of two or more candidate relay UEs; and to receive a response message via the transceiver 604 from the target network node, wherein the response message includes a handover request acknowledge message or a handover preparation failure message.

According to some other embodiments of the present application, when the apparatus 600 is a remote UE, the processor 602 is configured: to receive an radio resource control (RRC) reconfiguration message including a path switching indication via the transceiver 604 from a source network node, wherein the path switching indication includes: identifier (ID) information of one candidate relay UE of a target network node, or ID information of two or more candidate relay UEs of the target network node; in response to the path switching indication including the ID information of the one candidate relay UE, to perform a path switching operation to the one candidate relay UE; and in response to the path switching indication including the ID information of the two or more candidate relay UEs, to select one target relay UE within the two or more candidate relay UEs and to perform the path switching operation to the one target relay UE.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”.

1. A target network node, comprising:
at least one memory; and
at least one processor coupled with the at least one memory and configured to cause the target network node to:
receive a handover request message from a source network node, wherein the handover request message includes: identifier (ID) information of one candidate relay user equipment (UE), or ID information of two or more candidate relay UEs; and
transmit a response message to the source network node, wherein the response message includes a handover request acknowledge message or a handover preparation failure message.

2. The target network node of claim 1, wherein the handover request message includes ID information of a target cell of the target network node.

3. The target network node of claim 2, wherein in response to the handover request message including the ID information of the target cell, the one candidate relay UE and the two or more candidate relay UEs are served by the target cell.

4. The target network node of claim 1, wherein the handover request message further includes an indication for indicating the target network node to select a target relay UE.

5. The target network node of claim 4, wherein the indication is an indication for indicating the target network node to select a target relay UE served by a target cell of the target network node.

6. The target network node of claim 1, wherein the at least one processor is configured to cause the target network node to:
select one target relay UE; or
select two or more target relay UEs; and
transmit the handover request acknowledge message to the source network node, wherein the handover request acknowledge message includes ID information of the one target relay UE or ID information of the two or more target relay UEs.

7. The target network node of claim 1, wherein the at least one processor is configured to cause the target network node to:
in response to the handover request message including the ID information of the one candidate relay UE, determine whether the one candidate relay UE can serve a UE; and
in response to determining that the one candidate relay UE can serve the UE, transmit the handover request acknowledge message including the ID information of the one candidate relay UE to the source network node.

8. The target network node of claim 1, wherein the at least one processor is configured to cause the target network node to:
in response to the handover request message including the ID information of the one candidate relay UE, determine whether the one candidate relay UE can serve a UE; and
in response to determining that the one candidate relay UE cannot serve the UE, transmit the handover preparation failure message to the source network node.

9. The target network node of claim 1, wherein the at least one processor is configured to cause the target network node to, in response to the handover request message including the ID information of the one candidate relay UE:
select a first target relay UE different from the one candidate relay UE, and
transmit the handover request acknowledge message including ID information of the first target relay UE to the source network node.

10. The target network node of claim 1, wherein the at least one processor is configured to cause the target network node to:
in response to the handover request message including the ID information of the two or more candidate relay UEs:
select a first target relay UE within the two or more candidate relay UEs; or
select two or more target relay UEs within the two or more candidate relay UEs; or
select a second target relay UE different from the two or more candidate relay UEs; and
transmit the handover request acknowledge message to the source network node, wherein the handover request acknowledge message includes: ID information of the one target relay UE, ID information of the two or more target relay UEs, or ID information of the second target relay UE.

11. The target network node of claim 10, wherein the handover request acknowledge message includes ID information of a target cell of the target network node.

12. The target network node of claim 11, wherein in response to the handover request acknowledge message including the ID information of the target cell, the first target relay UE and the second target relay UE are served by the target cell.

13. The target network node of claim 11, wherein the ID information of the target cell includes a cell global ID, and wherein the cell global ID includes at least one of: a public land mobile network (PLMN) ID, or a cell ID of the target cell.

14. A source network node, comprising:
at least one memory; and
at least one processor coupled with the at least one memory and configured to cause the source network node to:
decide to switch a user equipment (UE) to a target relay UE, wherein the target relay UE is served by a target network node;
transmit a handover request message to the target network node, wherein the handover request message includes: identifier (ID) information of one candidate relay UE, or ID information of two or more candidate relay UEs; and
receive a response message from the target network node, wherein the response message includes a handover request acknowledge message or a handover preparation failure message.

15. A user equipment (UE), comprising:
at least one memory; and
at least one processor coupled with the at least one memory and configured to cause the UE to:
receive an radio resource control (RRC) reconfiguration message including a path switching indication from a source network node, wherein the path switching indication includes: identifier (ID) information of one candidate relay UE of a target network node, or ID information of two or more candidate relay UEs of the target network node;
in response to the path switching indication including the ID information of the one candidate relay UE, perform a path switching operation to the one candidate relay UE; and
in response to the path switching indication including the ID information of the two or more candidate relay UEs, select one target relay UE within the two or more candidate relay UEs and to perform the path switching operation to the one target relay UE.

16. A method performed by a target network node, the method comprising:
receiving a handover request message from a source network node, wherein the handover request message includes: identifier (ID) information of one candidate relay user equipment (UE), or ID information of two or more candidate relay UEs; and
transmitting a response message to the source network node, wherein the response message includes a handover request acknowledge message or a handover preparation failure message.

17. The method of claim 16, wherein the handover request message includes ID information of a target cell of the target network node.

18. The method of claim 17, wherein in response to the handover request message including the ID information of the target cell, the one candidate relay UE and the two or more candidate relay UEs are served by the target cell.

19. The method of claim 16, wherein the handover request message further includes an indication for indicating the target network node to select a target relay UE.

20. The method of claim 19, wherein the indication is an indication for indicating the target network node to select a target relay UE served by a target cell of the target network node.
